(19) United States
(12) Patent Application Publication
(10) Pub. No.: US 2012/0079270 A1
(43) Pub. Date: Mar. 29, 2012

(54) Hardware-Assisted Content Protection for Graphics Processor

(76) Inventor: Navin PATEL, Brampton (CA)

(21) Appl. No.: 12/893,895

(22) Filed: Sep. 29, 2010

(51) Int. Cl. H04L 9/00

(52) U.S. Cl. 713/165

(57) ABSTRACT

Methods, systems, and computer program products for the secure handling of content provider protected multimedia content are disclosed. A method for providing secure handling of provider protected multimedia content, includes: decrypting, in a hardware-based multimedia content protection device (MMCP), the provider protected multimedia content using one or more provider keys; encrypting, in the MMCP, the decrypted multimedia content using one or more local keys to create locally protected multimedia content; and providing the locally protected multimedia content to a graphics processor over a secure connection. In an embodiment, the MMCP and the graphics processor are on the same board. In another embodiment, the MMCP is incorporated in the graphics processor to form a unified chip.

### BACKGROUND OF THE INVENTION

1. Field of the Invention

The present invention relates to multimedia content protection.

2. Background Art

The demand from end users for multimedia content is continuously expanding. End users, or subscribers, demand increased and flexible access to digital multimedia content. Responding to the increased demand, content providers seek ways in which they can distribute multimedia content in the most technologically efficient economically advantageous manner that is also acceptable to end users.

With such facilities as time-shifting, end users often seek the ability to save or store distributed content in a manner that enables them to view the content at convenient times, not necessarily concurrent with the time at which the content is originally distributed. Often, the end user has the ability to record distributed content on a data storage device, such as a local disk drive, to be played back later at the convenience of the end user.

The content providers, such as content providers for cable and/or satellite television, typically distribute content to set-top boxes located at end user premises. The set-top boxes can include the capability to receive protected content, decrypt, and distribute the decrypted content to a display device such as a television. The decrypted content is typically encoded to an appropriate format for the display device. For example, the decrypted content can be encoded to be Analog NTSC/PAL, VGA, HDMI, DisplayPort etc. The set-top boxes, can have embedded in them one or more keys to decrypt the content distributed by one or more content providers.

Conventional methods of distributing content to end users have several shortcomings. The increased demand for flexible access and the ability to copy content in bulk increases the opportunities for piracy of the content originally distributed by content providers. According to conventional methods, although the content is protected up to its receipt by the set-top box, the content which is decrypted in the set-top box may be transmitted to a third device, such as a display device or storage device, in an unprotected form. Unauthorized access to the unprotected content can be made at various points in the chain of events from the initial decryption of the provider protected content to its eventual display.

What are needed, therefore, are methods and systems for improving the security of multimedia content received from content providers at end user locations.

### BRIEF SUMMARY OF EMBODIMENTS OF THE INVENTION

Methods, systems, and computer program products for the secure handling of content provider protected multimedia content are disclosed. A method for providing secure handling of provider protected multimedia content, includes: decrypting, in a hardware-based multimedia content protection device (MMCP), the provider protected multimedia content using one or more provider keys; encrypting, in the MMCP, the decrypted multimedia content using one or more local keys to create locally protected multimedia content; and providing the locally protected multimedia content to a graphics processor over a secure connection (e.g., a connection that is secure or a connection that has been secured). In an embodiment, the MMCP and the graphics processor are on the same board. In another embodiment, the MMCP is incorporated in the graphics processor to form a unified chip.

Another embodiment is a system for providing secure handling of provider protected multimedia content. The system includes a graphics processor and a hardware-based multimedia content protection device (MMCP). The MMCP includes a private memory comprising one or more local keys and an encryption/decryption module. The MMCP is configured to: decrypt the provider protected multimedia content using one or more provider keys; encrypt the decrypted multimedia content using one or more local keys to create locally protected multimedia content; and provide the locally protected multimedia content to a graphics processor over a secure connection.

Yet another embodiment is a tangible computer program product comprising a computer readable medium having computer program logic recorded thereon for causing a hardware-based multimedia content protection device (MMCP) and a graphics processor to securely handle provider protected multimedia content using a method. The method includes: decrypting, in the MMCP, provider protected multimedia content using one or more provider keys; encrypting, in the MMCP, the decrypted multimedia content using one or more local keys to create locally protected multimedia content; and providing the locally protected multimedia content to the graphics processor over a secure connection.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 illustrates a computing system with content protection, according to an embodiment of the present invention.

FIG. 2 illustrates a multimedia content protection device, according to an embodiment of the present invention.

FIG. 3 illustrates a multimedia content protection device incorporated in a graphics processor device, according to an embodiment of the present invention.

FIG. 4 illustrates a flowchart for providing content protection, according to an embodiment of the present invention.

FIG. 5 illustrates a flowchart for establishing a secure communication channel between a multimedia content protection device and a graphics processor device, according to an embodiment of the present invention.

### DETAILED DESCRIPTION OF EMBODIMENTS OF THE INVENTION

Embodiment of the present invention can yield substantial improvements in the secure distribution of protected multimedia content. While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention may be used in any computer system, computing device, entertainment system, media system, game systems, communication device, personal digital assistant, or any system using one or more processors to receive and display/store content including one or more of video, audio, image, or text content. The present invention, in some embodiments, performs hardware-assisted multimedia content protection. The multimedia content can include one or more of video, audio, images, text, and other forms of data. Embodiments of the present invention facilitate effective and flexible conditional access, such as, where content providers desire to ensure that only authorized users are able to access protected content. Conditional access providers can desire that even when users are able to record and view content on various platforms, that the content is protected from unauthorized access. In an embodiment, a multimedia content protection (MMCP) device is placed physically close to a graphics processor, and the graphics processor and the MMCP device is coupled by a secure or secured bus. In another embodiment, the MMCP device is integrated into the graphics processor (which may itself be integrated into other devices). The MMCP device performs the decryption of protected multimedia content from content providers, performs conditional access, and can re-encrypt the content using local keys before providing the content to the graphics processor for subsequent storage or rendering. By encrypting the content with local keys, the content is restricted to be used on only the encrypting platform. Also, in embodiments of the present invention, the central processor unit (CPU) of the system is freed from performing decrypting of protected content received from content providers and from performing conditional access.

Computing System with Content Protection

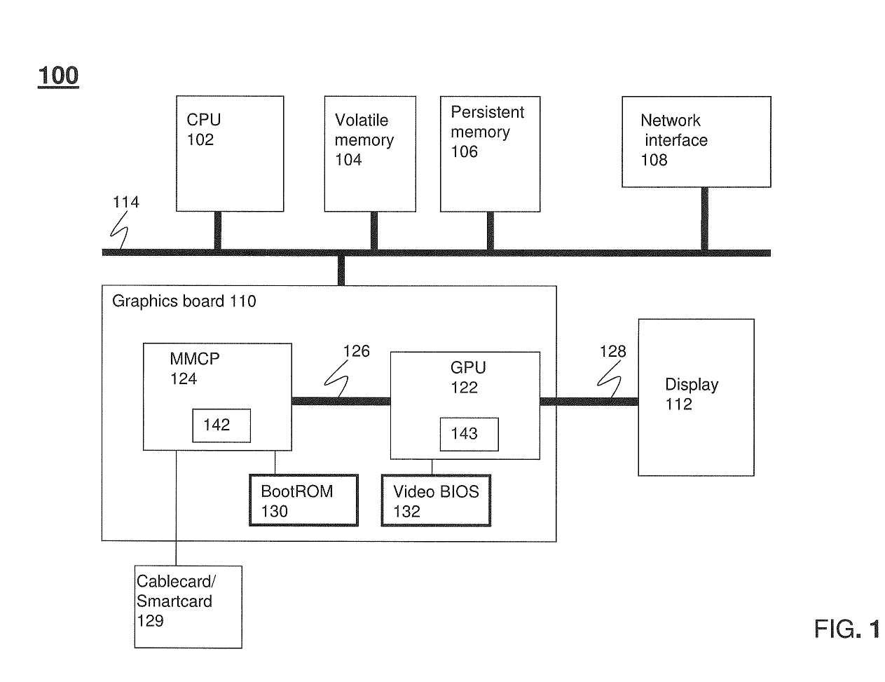

An example computing system 100 with content protection, according to an embodiment of the present invention, is shown in FIG. 1. Computing system 100 can include one or more CPUs 102, and one or more graphics processors, such as GPU 122. In other embodiments, one or more GPUs 122 may be included in one or more CPUs 102. Computing system 100 can also include at least one volatile memory 104, at least one persistent storage device 106, at least one network interface 108, one or more display devices 112, and at least one system bus 114. Computing system 100 can also include a multimedia content protection (MMCP) device 124. MMCP 124 can be coupled to GPU 122 by a private bus 126. Private bus 126 is a secure communication channel based on one or more means. Communications between MMCP 124 and GPU 122 over bus 126 are required to be encrypted. The communication over bus 126 can be encrypted, for example, using Advanced Encryption Standard (AES) encryption. In addition, security is enhanced by requiring the bus to cover only a short physical distance between the MMCP and GPU. According to an embodiment, MMCP 124 and GPU 122 are incorporated on a board 110. Incorporating the MMCP 124 and GPU 122 on a single board 110 facilitates the placement of the MMCP and GPU in close proximity to each other, and thereby enables private bus 126 to span only a short physical distance.

CPU 102 can include any commercially available control processor, a custom control processor, field programmable gate array (FPGA), application specific integrated circuit (ASIC), or digital signal processor (DSP). CPU 102, for example, executes the control logic that controls the operation of computing system 100.

GPU 122, for example, can execute specialized code for selected functions such as graphics operations. GPU 122 includes its own processing cores, such as, for example, one or more single instruction multiple data (SIMD) processing cores. Each GPU processing element can include one or more of a scalar and vector floating-point units. The GPU processing elements can also include special purpose units such as inverse-square root units and sine/cosine units. GPU 122 can include its own memory. In general, GPU 122 can be used to execute graphics functions such as graphics pipeline computations such as geometric computations and rendering of image on a display. Typically, CPU 102 sends to GPU 122 selected instructions, such as graphics instructions, to be executed substantially independently from the CPU.

Volatile memory 104 can include at least one non-persistent memory such as dynamic random access memory (DRAM). Volatile memory 104 can hold processing logic instructions, constant values and variable values during execution of portions of applications or other processing logic. For example, in one embodiment, parts of control logic to perform process 400 can reside within system memory 104 during execution of the respective portions of process 400 by CPU 102. The term “processing logic,” as used herein, refers to control flow instructions, instructions for performing computations, and instructions for associated access to resources.

Persistent memory 106 includes one or more storage devices capable of storing digital data such as magnetic disk, optical disk, or flash memory. Persistent memory 104 can, for example, store at least parts of instruction logic of process 400. For example, at the startup of computing system 100, the operating system and other application software can be loaded in to volatile memory 104 from persistent storage 106.

Network interface 108 includes one or more interfaces connecting computer system 100 to one or more communication networks, such as, a local area network (LAN) or wide area network (WAN).

Display 112 can include a display device such as a monitor, screen, television, and the like. Display 112 can be coupled to GPU 122 via an interface 128. Interface 128 can include a display interface such as a Firewire interface, an HDMI interface or a DisplayPort interface.

System bus 114 can include a Peripheral Component Interconnect (PCI) bus, Advanced Microcontroller Bus Architecture (AMBA) bus, Industry Standard Architecture (ISA) bus, or such a device. System bus 114 can also include a network such as a local area network (LAN). System bus 114 includes the functionality to couple components including components of heterogeneous computing system 100.

MMCP 124 can be an ASIC, FPGA, or DSP, that includes the functionality for encryption/decryption, secure key storage, and secure key management. In some embodiments, MMCP 124 includes the functionality for conditional access (CA). MMCP 124 can be physically hardened to increase security and to be made tamper-proof. For example, MMCP 124 can be designed such that an attempt to reprogram its one-time programmable memory can result in MMCP 124 being physically disabled.

MMCP 124 can be coupled to a smartcard and/or conditional access card 129. Smartcard 129 can include keys specific to a conditional access provider. Smartcard 129 can also include some level of encryption/decryption and authentication functionality. For example, smartcard 129 can be provided by the conditional access provider to perform authentication of the subscriber and/or the MMCP.

The logic to perform content protection can be distributed between MMCP 124 and GPU 122. For example, a first portion 142 of the logic to perform content protection can reside on MMCP 124, and a second portion 144 can reside on GPU 122. Logic 142 and 144 can include instructions specified in a programming language such as C and/or in a hardware description language such as Verilog, RTL, netlists, to enable ultimately configuring a manufacturing process through the generation of maskworks/photomasks to generate a hardware device embodying aspects of the invention described herein.

A person of skill in the art will understand that computing system 100 can include more or less components that shown in FIG. 1. For example, computing system 100 can include one or more input interfaces, and one or more output interface.

### A Multimedia Content Protection Device

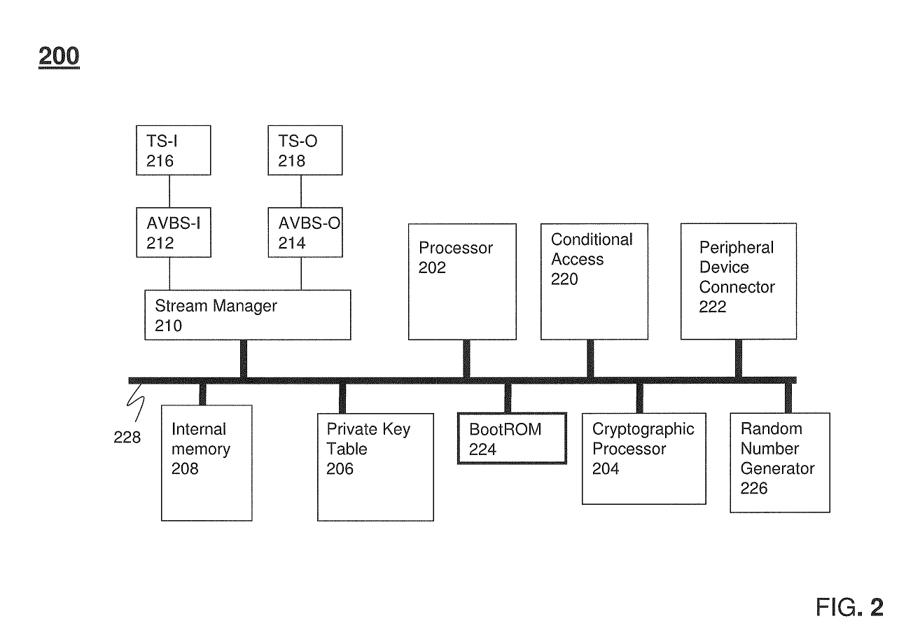

FIG. 2 illustrates an exemplary MMCP device 200, according to an embodiment of the present invention. MMCP 200 includes a processor 202, a cryptographic processor 204, a private key table 206, an internal memory 208, a content stream manager 210, and a peripheral controller 222. MMCP 200 can also include a conditional access module 220, a boot ROM module 224, and a random number generator module 226. In addition, MMCP 200 includes transport stream input 216 and output 218 blocks, and audio/video bitstream input 212 and output 214 blocks.

Processor 202 can be a processor dedicated to MMCP 200. Processor 202 can include the functionality to execute the boot firmware upon startup to initialize the MMCP 200 for further operation. Processor 202 can also include the functionality to control the data manipulation of bit streams and to handle key management.

Cryptographic processor 204 can be a processor optimized for cryptographic functions such as encryption and decryption. According to an embodiment, cryptographic processor 204 includes the functionality to perform encryption and decryption according to AES. For example, cryptographic processor 204 can perform the re-encryption of content using AES keys before the content is transmitted to the GPU to be rendered. Cryptographic processor 204 and/or random number generator 226 can generate one or more cryptographic keys to be used as local keys for locally re-encrypting content in the MMCP before being sent to the GPU for rendering or storage. The cryptographic keys for local re-encryption of content can be generated based on one or more of the MMCP's unique serial number and/or values configured in the private key table 206. According to another embodiment, cryptographic keys for local re-encryption can be programmed into the MMCP at the time of manufacture.

Private key table 206 is a non-volatile memory such as an electrically programmable read only memory (EPROM) that is used to hold one or more keys programmed at the time of manufacture. According to an embodiment, private key table 206 is a one-time programmable memory. The keys in private key table 206 can be verified by the Boot ROM firmware, using a cyclic redundancy check (CRC) checksum. The keys may be generated based on a unique serial number assigned to chip 200 at the time of manufacture. According to an embodiment, private key table 206 includes a device secret key for the MMCP 200, which may have been assigned at the time of manufacture.

In another embodiment, private key table 206 is a volatile or non-volatile memory that is protected from unauthorized access by software. For example, software can intercept and authenticate requests to access private key table 206 memory. This can be useful when, for example, the device secret key for MMCP 200 is the private key from a public/private key pair and the keys are received from a key server.

Internal memory 208 can include volatile and/or non-volatile memory and is used as memory for processing within MMCP 200. According to an embodiment, internal memory 208 can be used for holding instructions and data during execution of programs on MMCP 200. In some embodiments, internal memory 208 can be used to store one or more authentication and/or cryptographic keys.

Content stream manager 210 includes logic to direct content to various modules and memory internal to MMCP 200. For example, stream manager 210 can include a multiplexer/demultiplexer to combine and/or separate various content and message streams. According to an embodiment, stream manager 210 separates the audio, video, and control message streams received from a content provider.

Peripheral controller 222 includes functionality for the MMPC to communicate with various peripheral devices, such as, but not limited to, general purpose input/output (GPIO) interface, a universal asynchronous receiver/transmitter (UART), a smartcard interface, and a universal serial bus interface (USB). The smartcard interface, for example, can be used to couple MMCP 200 to a smartcard or cable card provided by a content provider.

Conditional access module 220 includes logic to perforin conditional access functions, such as, recovering keys transmitted from the content provider, and for exchanging entitlement control messages (ECM) and entitlement management messages (EMM) with the content provider. For example, conditional access module 220 can receive an ECM from the content provider that carries a control word with which content is scrambled. At the content provider, the control word can be encrypted with a authentication key before it is embedded in the ECM. The authentication key can be specific to a subscriber and selected content. The authentication key, in turn, can be encrypted with a subscriber key which is specific to the subscriber and transmitted to the MMCP using a entitlement management massage (EMM). The subscriber key can be distributed to end users embedded and/or programmed in smartcards, and the end users can couple the smartcards to their respective MMCP to provide the MMCP access to the subscriber key. Upon receipt of the EMM, the MMCP can retrieve the authentication key embedded in the EMM message by decrypting the encrypted body of the EMM message using the subscriber key. Upon receipt of the ECM, the MMCP and/or the smartcard can decrypt the encrypted body of the ECM to recover the control word. The control word, in turn, can be used by the MMCP to decrypt scrambled and/or encrypted content received from the content provider. According to an embodiment, conditional access module 220 includes the capability to trans-script bit streams into various content protection schemes using hardware. For example, content in the formats of digital video broadcast common standard algorithm (DVB-CSA), Multi2 block cipher, Triple Data Encryption Standard (TDES), data Encryption Standard (DES), and CSS block cipher, can be supported in conditional access module 220. According to an embodiment, the conditional access module 220 can include support for DCAS (CableLab Downloadable Conditional Access System).

Boot ROM module 224 includes the firmware responsible for initializing the MMCP upon startup, and for bringing the MMCP into a known good state.

Random number generator 226 includes logic to generate a random number, for example, for generating keys locally on the MMCP. According to an embodiment, random number generator is implemented in hardware and is configured to generate one or more random numbers upon demand.

Transport stream 216 interface is an interface that is configured to receive a data stream, including content, from one or more content providers and/or intermediate entities. Transport stream 218 is an interface configured to transmit a data stream to another location or entity.

Audio/video interface 212, coupled to transport stream 216, is configured to receive audio, video and other data from a graphics processor or other content provider or distributor. In various embodiments, audio/video interface 212 is configured for one or more of terrestrial, cable and satellite modes of content distribution.

Audio/video interface 214, coupled to transport stream 218, can support both serial and parallel transport stream outputs. Transport data can be sent to a graphics processor or other entity that uses the MMCP processed content.

Interconnection bus 228 interconnects various modules of the MMCP. Interconnection bus can include, for example, one or more PCI buses and/or one or more AMBA buses.

The MMCP device can be enhanced for physical security by, for example, including the bus and memory in the middle of ASIC layers, by using ball grid array (BGA) packaging, and Nitric Acid protection on die.

### MMCP Integrated Graphics Processor

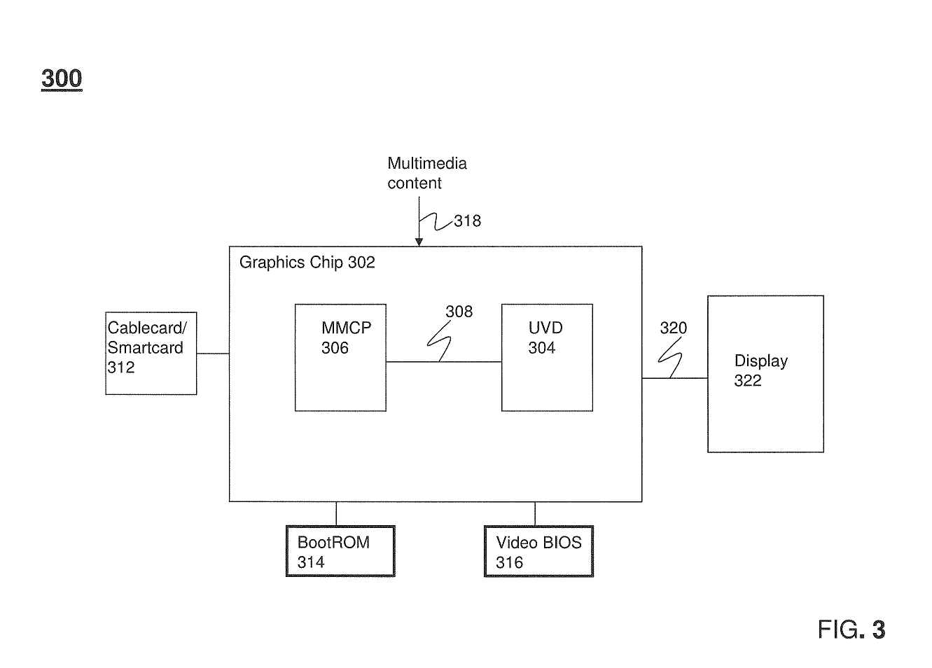

FIG. 3 illustrates a content protection system 300 in which graphics processor 302 includes an integrated MMCP 306. According to an embodiment, MMCP 306 is incorporated in the same chip as the rest of the graphics processing functions. For example, MMCP 306 can be incorporated in the same die as the rest of the functional blocks of a GPU to form a single chip graphics processor incorporating secure multimedia content protection. MMCP 306 is coupled to a universal video decoder 304 via an interface 308. MMCP 306, for example, can include the set of modules described with respect to FIG. 2 above. MMCP 306 receives conditional access protected content and creates a version of the content for local use. For example, the content may be decrypted, and re-encrypted with local keys that the MMCP 306 shares with UVD 304. Universal video decoder 304 receives content processed by MMCP 306 and either stores the content for later use, or performs the rendering of that content. Due to having the MMCP embedded in the same chip as the video decoder, interface 308 is highly secure. In this embodiment, additional software-based protection of the interface between MMCP and UVD 304 may not be necessary because the connection is entirely within graphics processor 302.

Graphics processor 302 can be coupled to one or more devices, such as, a smartcard 312, a boot ROM 314, a video BIOS 316, a content source 318, and a display 320. Smartcard 312 can be a device such as a cable card that includes one or more keys necessary for decrypting and/or authenticating conditionally protected content from a content provider. Boot ROM 314 includes firmware that initializes MMCP 306 to a known state at startup. Video BIOS 316 can include configuration for graphics processor 302. Graphics processor 302 receives content from content source 318. Content source 318 can be coupled to graphics processor 302 through a connection to a computing system such as a connection to a personal computer. Display 320 can include a monitor and is coupled to graphics processor 302 by a display interface 322. Display 322 can include an interface such as HDMI, Firewire, or DisplayPort.

### Method for Providing Hardware-Assisted Content Protection

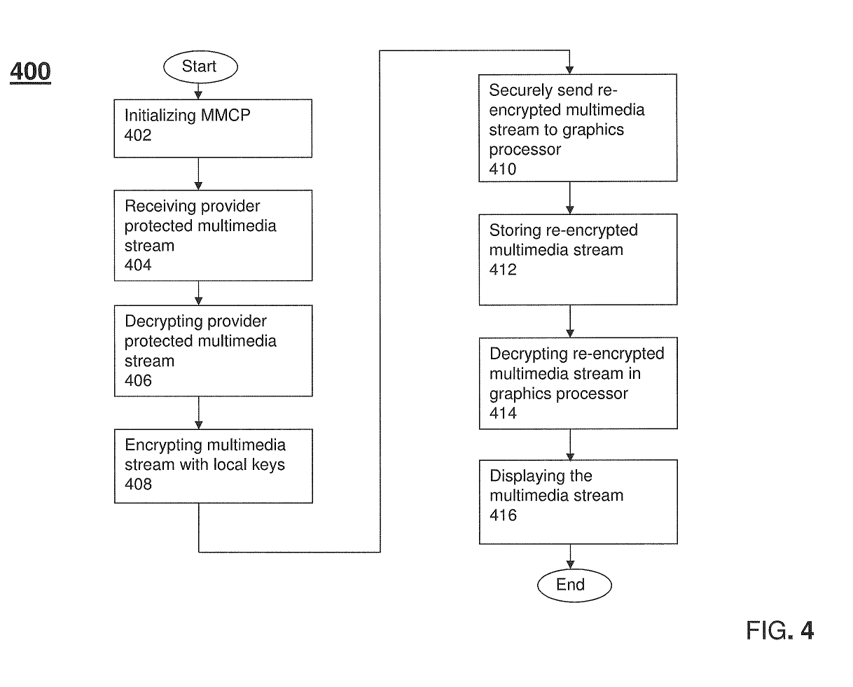

FIG. 4 illustrates a method 400 to provide hardware-assisted content protection, according to an embodiment of the present invention. Method 400, for example, can be implemented by logic components 142 and 143 located in MMCP 124 and GPU 122, respectively.

In step 402, the MMCP is initialized. According to an embodiment, the MMCP is initialized upon startup of either the system (e.g., personal computer, handheld computer, entertainment platform, and the like) incorporating the MMCP, or of the MMCP alone. Initialization can include the flushing of internal memory, such as internal volatile memory, cached data, and operational state information. Initialization can also include the MMCP acquiring the keys necessary for conditional access and content protection from the content provider. In some embodiments, one or more keys can be acquired (or reacquired) from the content provider by exchanging messages with the content provider or with a proxy of the content provider. In some embodiments, one or more keys can be acquired from a smartcard, such as a cable card, provided by the content provider and coupled to the MMCP. For example, a subscriber secret key can be recovered from a smartcard distributed by the content provider to each subscriber. Other keys can be recovered by exchanging ECM and EMM messages with the content provider.

In step 404, the MMCP receives protected multimedia content. The protected content has been previously encrypted by the content provider. The protected content can be received from a conditional access provider, such as, a cable content provider, a satellite content provider, or the like. The content provider transmits a stream of content that is encrypted with, for example, a control word. The control word used for encrypting a content stream reflects the authorization required for a subscriber to view that content. For example, the content of a pay per-view movie can be protected using a control word generated by the content provider for the subscriber based on the subscriber's authorized set of services. In general, the content provider communicates the control word and any other keys required for decrypting the content to the subscriber using EMM, ECM, and other key distribution methods such as cable cards. For example, keys necessary for authentication of the MMCP and subscriber, as well as the keys necessary for encryption and decryption can be put in place at the time of initialization. Keys that change with modifications to subscribers level of service and authorization, and keys such as control words used for protecting individual content streams can be received by the MMCP from the content provider during operation.

In step 406, the protected content stream is decrypted. For example, the protected content stream can be decrypted using a key, such as a control word, received by the MMCP from the content provider. The control word used for decrypting protected content from the content provider can, for example, be stored in internal memory of the MMCP. In embodiments of the present invention, the MMCP can receive and decrypt one or more protected streams of content simultaneously. The MMCP can simultaneously store and/or use one or more sets of keys. The one or more sets of keys can be associated with the same or different content providers. The decryption of the content stream is performed in the MMCP, for example, using cryptographic processor 204. According to an embodiment, the entire process of decrypting the received protected content is performed without the direct involvement of the CPU of the system (e.g., CPU 102). By freeing the CPU of the system from compute-intensive tasks, such as the decryption and encryption of content streams, embodiments of the present invention improve the performance of the overall system.

When the content-provider protected content stream is decrypted, the content is no longer in a secure form. According to an embodiment, the decrypted content is held within the MMCP, for example, in an internal memory. In step 408, the decrypted content is re-encrypted with one or more local keys. One or more local keys can be generated by the MMCP, for example, by a cryptographic processor incorporated in the MMCP using a random number generator, also incorporated in the MMCP. Local keys can also be factory generated and stored in a one-time programmable memory. The keys stored in the one-time programmable memory can, for example, be provided by content-providers and board manufacturers.

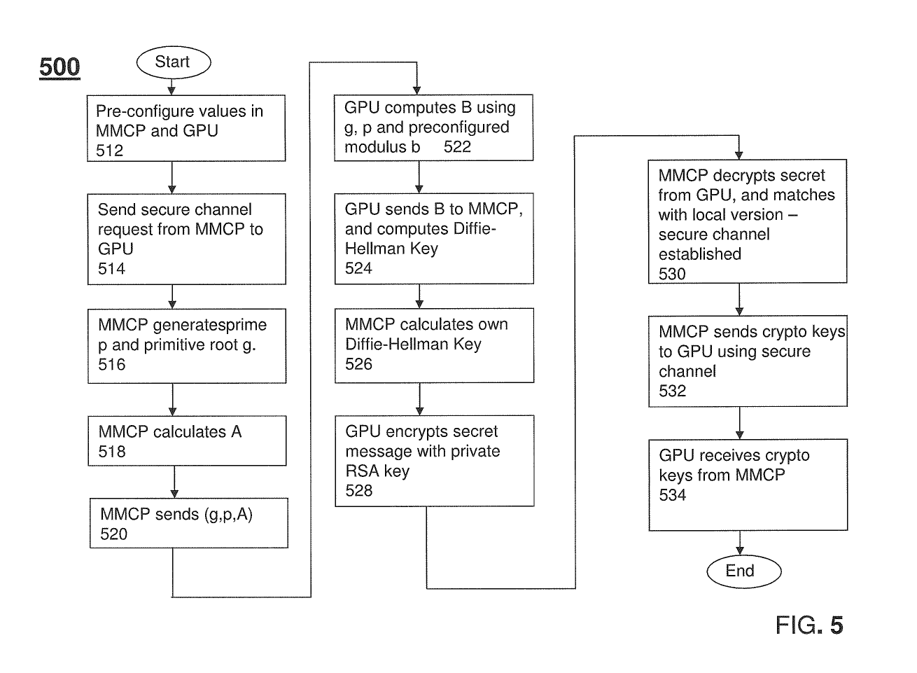

In step 410, the locally re-encrypted content is securely provided to a graphics processor. According to an embodiment, the locally re-encrypted content is transferred from the MMCP to the graphics processor over a secure channel. In an embodiment, the secure channel comprises a logical channel in which the transmitted content is encrypted. In various embodiments, the logical channel may be over a physically secure communication medium. A secure logical channel is further described below in relation to FIG. 5. A person of skill in the art would appreciate that by placing the MMCP at a close distance from the graphics processor, physical measures employed for unauthorized detection and monitoring of data transferred over the communication channel between the MMCP and graphics processor can be reduced.

In step 412, optionally, the graphics processor can store the locally re-encrypted content on a storage device. The storage device can be a hard-disk, a compact disk, digital video disk, a flash disk, or other volatile or non-volatile storage medium. The storage device can be a device permanently attached to the system in which the MMCP and graphics processor reside, or it can be a detachable device. By locally re-encrypting the content before storage, however, it is ensured that the content can be decrypted and rendered to a display only by the graphics processor possessing the necessary keys. Thus, for example, even if the content is stored in a detachable storage device, another system which does not have the required keys cannot decrypt the content. According to an embodiment, step 412 can store the re-encrypted content on the hard-disk of a personal computer for playback at a later time.

In step 414, the graphics processor receives the re-encrypted content either directly from the MMCP, or from the storage device in which the content was previously stored. According to an embodiment, step 414 can be invoked when a subscriber requests playback of a previously stored multimedia content. According to another embodiment, step 414 can be invoked to playback a multimedia stream that is being concurrently received in protected form from a content provider, and is being processed for local use by the MMCP.

In step 416, the locally re-encrypted content is decrypted and is rendered to a display. According to an embodiment, the decryption is performed by the graphics processor using a cryptographic block residing in the graphics processor. The keys required for decryption within the graphics processor can be received securely from the MMCP. The secure receiving of keys in the graphics processor is further described below in relation to FIG. 5.

In another embodiment, the re-encrypted content can be directly rendered to a display by the graphics processor, without the intermediate steps of storing the re-encrypted data and subsequently recovering the stored content. For example, a multimedia content stream being received from a content provider in protected form, can be processed by the MMCP and sent to the graphics processor for concurrent display to the subscriber.

As would be understood by a person of skill in the art, the process of receiving content protected by a content-provider according to embodiments of the present invention, for example, by decrypting the content, and then securely handling the content within a platform such as a set-top box, personal computer, handheld or other device, in which the graphics processor and a proximately placed MMCP collaborate to secure the content for storage or for local display, can be accomplished using methods having one or more additional steps, different steps, or one or more less steps, than those described in relation to method 400.

FIG. 5 is an illustration 500 of a message exchange sequence to establish a secure communication channel between the MMCP and the graphics processor to, for example, exchange the keys used for locally protecting the multimedia content. As described above, in embodiments of the present invention, the local keys are used to re-encrypt multimedia content at the MMCP before being transmitted to the GPU for storage or display. Also, as described above, the local keys are managed by the MMCP, and can be either generated by the MMCP, preconfigured, or received from an external source such as a content provider. According to an embodiment, the MMCP generates one or more local keys and securely inform the GPU of the values of the generated keys. According to an embodiment, the MMCP establishes a secure logical communication channel over which they can exchange key information. The GPU decrypts the multimedia content using the local keys before rendering the content.

According to an embodiment, the secure logical channel between the GPU and MMCP is based upon encrypting the communications using a mutually agreed upon key. The GPU and MMCP agree to a key using the Diffie-Hellman key agreement algorithm using method 500. In step 512, MMCP and GPU, respectively, are pre-configured with modulus a and modulus b. According to an embodiment, modulus a can be stored in the private key table of MMCP and the time of manufacture, or at a later time of secure configuration. Modulus b can be stored in GPU firmware or in the GPU driver. Modulus a and b are the only secrets required for the Diffie-Hellman key exchange. In addition, a secret message M can be preconfigured in the MMCP and GPU to be used to prevent man-in-the-middle attacks. The GPU is also preconfigured with a private authentication key k_{private,GPU} based on a public-key crypto system such as RSA. The private key can either be preprogrammed into the GPU or can be acquired by the GPU using a key distribution method. The MMCP is similarly preconfigured with the public key k_{public,GPU} of the GPU.

In step 514, the GPU requests a secure channel from the MMCP. The GPU can assert a predetermined signal or send a message to the MMCP when it is ready to receive and configure local keys. According to another embodiment, the MMCP can initiate the key agreement process by, for example, directly proceeding to step 514.

In step 516, the MMCP sends values p, g, and A to the GPU. The MMCP can generate the values p and g each time a new secure connection is needed to communicate with the GPU. p is a prime number, typically a large value. g is a primitive root modulo p, i.e., g is a generator of the multiplicative group of integers modulo p. These values can be generated in the cryptographic processor and/or the random number generator in the MMCP.

In step 518, MMCP computes A=g^{a} mod p. Values g and p were generated in step 516, and value of a is preconfigured.

In step 520, the values (g, p, A) are transmitted to the GPU from the MMCP.

In step 522, the GPU computes B=g^{b} mod p. GPU received g and p values from the MMCP. b is preconfigured in the GPU.

In step 524, the GPU transmits B to the MMCP. The GPU also computes key K_{Diffie} as, K_{Diffie}=A^{b} mod p.

In step 526, the MMCP receives B from the GPU, and calculates its own key K_{Diffie} as, K_{Diffie}=B^{a} mod p. Due the mathematical properties of g and p, the values of K_{Diffie} separately computed by the MMCP and the GPU are the same. Therefore, at the end of step 526, the MMCP and GPU have agreed on key K_{Diffie} with which to encrypt communications between them.

In step 528, the GPU encrypts the preconfigured secret message M using its private key k_{private,GPU}, and sends the encrypted message E_{kprivate,GPU}(M) to MMCP.

In step 530, MMCP receives E_{kprivate,GPU}(M) from GPU and uses the public key k_{public,GPU} of the GPU to decrypt the message M. MMCP then compares the decrypted message M with the corresponding preconfigured secret message, and if they match the secure logical channel is considered established between the MMCP and GPU.

In step 532, the MMCP sends to the GPU the cryptographic keys that are to be used as local keys for the re-encryption and decryption of multimedia content. According to an embodiment, the MMCP encrypts the cryptographic keys using the Diffie-Hellman key K_{Diffie} mutually agreed with the GPU in step 526.

In step 534, the GPU receives the cryptographic keys to be used as local keys for the decryption of content prior to rendering.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of providing secure handling of provider protected multimedia content, comprising:
decrypting, in a hardware-based multimedia content protection device (MMCP), the provider protected multimedia content using one or more provider keys;
encrypting, in the MMCP, the decrypted multimedia content using one or more local keys to create locally protected multimedia content; and
providing the locally protected multimedia content to a graphics processor over a secure connection.

2. The method of claim 1, further comprising:
configuring the MMCP and the graphics processor on a board.

3. The method of claim 1, further comprising:
configuring the MMCP and the graphics processor on a graphics chip.

4. The method of claim 1, further comprising:
receiving the provider protected multimedia content in the MMCP.

5. The method of claim 1, further comprising:
configuring a private logical channel to create the secure connection.

6. The method of claim 5, wherein configuring a private logical channel comprises:
exchanging key parameters between MMCP and the graphics processor according to a Diffie-Hellman algorithm to determine one or more Diffie-Hellman Keys.

7. The method of claim 6, further comprising:
exchanging a secret message between the MMCP and the graphics processor using public key cryptography.

8. The method of claim 1, further comprising:
storing the one or more provider keys in a one time programmable memory in the MMCP.

9. The method of claim 1, further comprising:
providing one or more second local keys corresponding to respective local keys from the MMCP securely to the graphics processor.

10. The method of claim 1, further comprising:
storing the locally protected multimedia content in a digital storage device.

11. The method of claim 1, further comprising:
decrypting the locally protected multimedia content in the graphics processor to create display multimedia content; and
displaying the display multimedia content.

12. The method of claim 11, further comprising:
receiving, in the graphics processor, the locally protected multimedia content from a digital storage device.

13. A system for providing secure handling of provider protected multimedia content, comprising:
a graphics processor; and
a hardware-based multimedia content protection device (MMCP) coupled to the graphics processor through a secure connection, the MMCP including:
a private memory comprising one or more local keys; and
an encryption/decryption module,
wherein the MMCP is configured to:
decrypt, in the MMCP, the provider protected multimedia content using one or more provider keys;
encrypt, in the MMCP, the decrypted multimedia content using one or more local keys to create locally protected multimedia content; and
provide the locally protected multimedia content to a graphics processor over a secure connection.

14. The system of claim 13, wherein the MMCP and the graphics processor are configured on a board.

15. The system of claim 13, wherein the MMCP and the graphics processor are configured on a graphics chip.

16. The system of claim 13, wherein the MMCP is further configured to:
provide one or more local keys from the MMCP securely to the graphics processor.

17. The system of claim 16, wherein the graphics processor is configured to:
decrypt the locally protected multimedia content using the one or more local keys.

18. The system of claim 13, wherein the MMCP further includes:
a conditional access module.

19. A tangible computer program product comprising a computer readable medium having computer program logic recorded thereon for causing a hardware-based multimedia content protection device (MMCP) and a graphics processor to securely handle provider protected multimedia content, the method comprising:
decrypting, in the MMCP, provider protected multimedia content using one or more provider keys;
encrypting, in the MMCP, the decrypted multimedia content using one or more local keys to create locally protected multimedia content; and
providing the locally protected multimedia content to the graphics processor over a secure connection.

20. The tangible computer program product, the method further comprising:
decrypting, in the graphics processor, the locally protected multimedia content using the one or more local keys.
